(19) United States
(12) Patent Application Publication
(10) Pub. No.: US 2014/0211108 A1
(43) Pub. Date: Jul. 31, 2014

(54) Electronic Device and Stand for Electronic Device

(71) Applicant: Kabushiki Kaisha Toshiba, Tokyo (JP)

(72) Inventors: Takuo Matsumoto, Hamura-shi (JP); Tetsuo Okazaki, Hino-shi (JP)

(73) Assignee: Kabushiki Kaisha Toshiba, Tokyo (JP)

(21) Appl. No.: 14/227,847

(22) Filed: Mar. 27, 2014

Related U.S. Application Data
(63) Continuation of application No. PCT/JP2013/058650, filed on Mar. 25, 2013.

(30) Foreign Application Priority Data
Jan. 28, 2013 (JP) 2013-013357

(51) Int. Cl. G06F 1/16; F16M 11/04; G06F 3/041

(52) U.S. Cl. CPC G06F 1/16; G06F 3/041; F16M 11/041
USPC 349/12; 361/679.02; 248/346.03

(57) ABSTRACT

According to one embodiment, electronic device includes display device, touch panel, first housing, second housing, connection portion, and movable portion. The first housing supports the display device. The second housing includes first end, second end opposite the first end, and intermediate portion between the first and the second ends. The connection portion is detachably connected to the first housing. The movable portion is rotatably supported by the second housing and moves the connection portion between first position at which the connection portion is close to the first end and second position at which the connection portion is supported by the intermediate portion. In a state in which the connection portion is located at the first position, the first housing and the second housing are foldable. In a state in which the connection portion is located at the second position, the first housing and the second housing are openable.

### CROSS-REFERENCE TO RELATED APPLICATIONS

This application is a continuation of International Application No. PCT/JP2013/058650, filed Mar. 25, 2013, which designates the United States, incorporated herein by reference, and which is based upon and claims the benefit of priority from Japanese Patent Application No. 2013-013357, filed Jan. 28, 2013, the entire contents of which are incorporated herein by reference.

### FIELD

Embodiments described herein relate generally to an electronic device and a stand for an electronic device.

### BACKGROUND

Conventionally, there has been known an electronic device having a movable arm and that can change the position of a display screen.

Such electronic device can possibly reduce inconveniences during use depending on the position of a housing supporting a display device, as an example.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view illustrating one example of an electronic device according to a first embodiment;

FIG. 2 is an exemplary schematic view illustrating an internal configuration of a first housing of one example of the electronic device in the first embodiment;

FIG. 3 is an exemplary perspective view illustrating one example of the electronic device in a state in which the first housing has been detached, in the first embodiment;

FIG. 4 is an exemplary side view illustrating one example of the electronic device in an opened state in which a connection portion is located at a second position in the first embodiment;

FIG. 5 is an exemplary side view illustrating the second housing of one example of the electronic device in the first embodiment;

FIG. 6 is an exemplary side view illustrating one example of the electronic device in a state in which the connection portion is located at a position between a first position and the second position, in the first embodiment;

FIG. 7 is an exemplary side view illustrating one example of the electronic device in a state in which the connection portion is located at a position between the first position and the second position that is different from the position in FIG. 6, in the first embodiment;

FIG. 8 is an exemplary side view illustrating one example of the electronic device in a folded state in which the connection portion is located at the first position in the first embodiment;

FIG. 9 is an exemplary side view illustrating one example of the electronic device in a state in which the first housing and the second housing are opened in a flat manner, in the first embodiment;

FIG. 10 is an exemplary cross-sectional view illustrating a hinge of one example of the electronic device in the first embodiment;

FIG. 11 is an exemplary view illustrating ball holders and balls comprised in the hinge of one example of the electronic device when viewed from the radial direction of rotating shafts, in the first embodiment;

FIG. 12 is an exemplary view illustrating the ball holders and the balls comprised in the hinge of one example of the electronic device when viewed from the shaft direction of the rotating shafts, in the first embodiment;

FIG. 13 is an exemplary view illustrating a ball guide comprised in a first hinge of one example of the electronic device when viewed from the radial direction of the rotating shaft in the first embodiment;

FIG. 14 is an exemplary view illustrating a ball guide comprised in a second hinge of one example of the electronic device when viewed from the radial direction of the rotating shaft, in the first embodiment;

FIG. 15 is an exemplary perspective view illustrating one example of the electronic device in a state in which the first housing is supported on the connection portion in a posture different from that in FIG. 1, in the first embodiment;

FIG. 16 is an exemplary side view illustrating an example of an electronic device in an opened state in which a connection portion is located at a second position according to a second embodiment;

FIG. 17 is an exemplary side view illustrating one example of the electronic device in a folded state in which the connection portion is located at a first position in the second embodiment; and

FIG. 18 is an exemplary side view illustrating one example of the electronic device in a state in which a first housing and a second housing are opened in a flat manner, in the second embodiment.

### DETAILED DESCRIPTION

In general, according to one embodiment, an electronic device comprises a display device, a touch panel, a first housing, a second housing, a connection portion, and a movable portion. The display device comprises a display screen. The touch panel is configured to detect an input operation on the display screen. The first housing is configured to support the display device. The second housing comprises a first end, a second end opposite the first end, and an intermediate portion between the first end and the second end. The connection portion is detachably connected to the first housing. The movable portion is configured to be rotatably supported by the second housing and to move the connection portion between a first position at which the connection portion is close to the first end and a second position at which the connection portion is supported by the intermediate portion. In a state in which the connection portion is located at the first position, the first housing and the second housing are foldable. In a state in which the connection portion is located at the second position, the first housing and the second housing are openable.

The following embodiments and modifications comprise the same or similar constituent components. Hereinafter, common reference numerals denote the same or similar constituent components and overlapped explanation thereof is omitted partially.

Furthermore, although an electronic device is configured as a personal computer in the following embodiments and modifications, the electronic device according to the embodiments is not limited thereto. The electronic device according to the embodiments can be configured as various types of electronic devices, such as a smartphone, a mobile phone, a personal digital assistant (PDAs), an electronic dictionary device, a video image display device, a video phone, and a display device with a software keyboard.

### FIRST EMBODIMENT

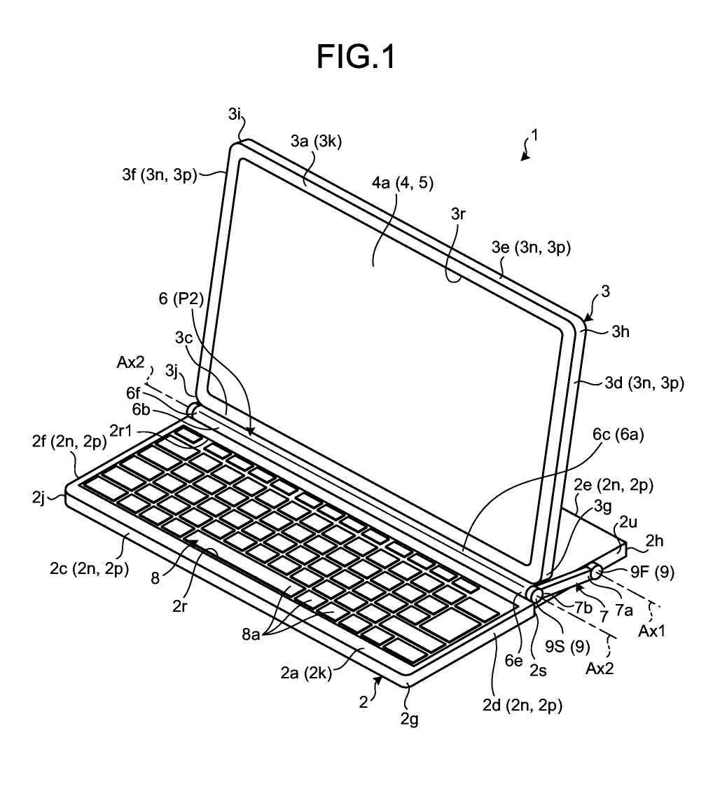

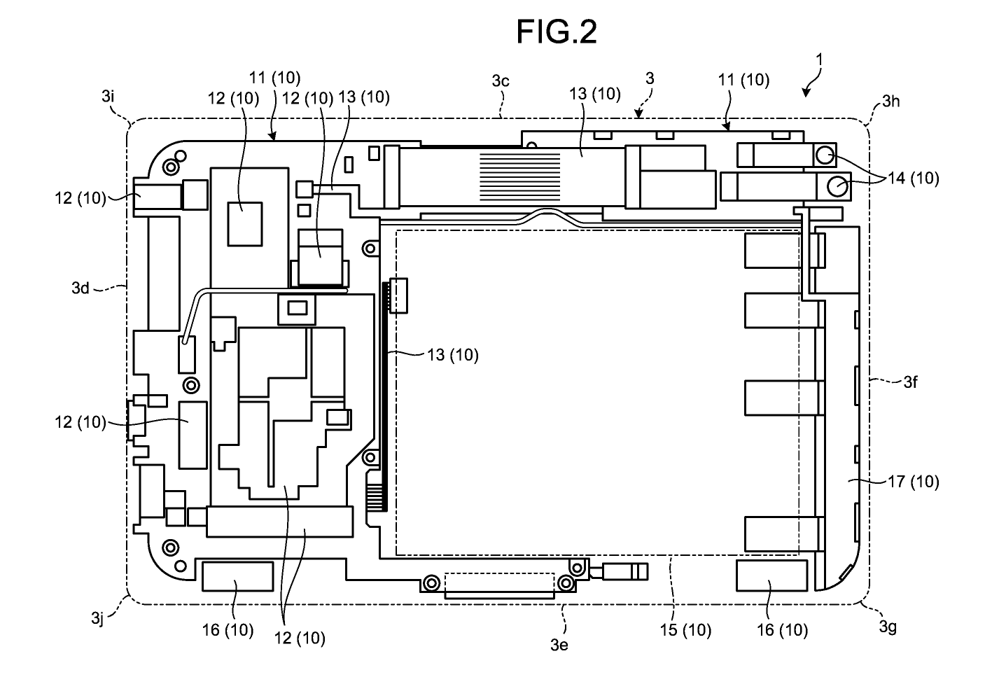

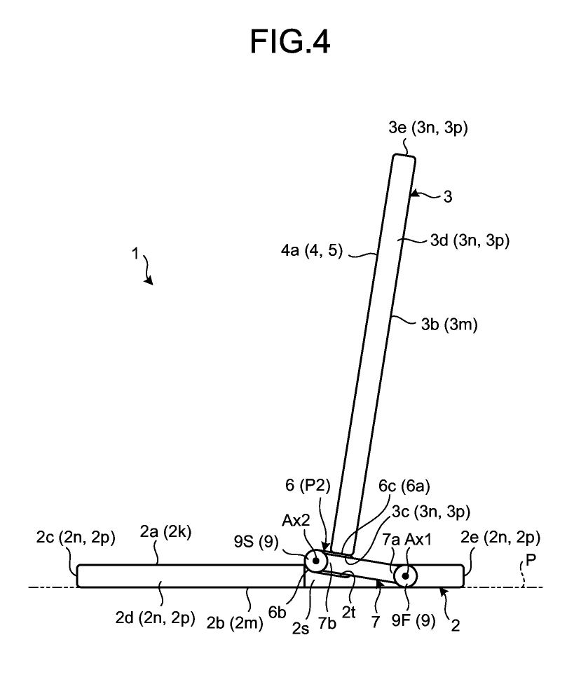

In the embodiment, as is obvious from FIGS. 1, 2, and the like, a housing 3 (first housing) of an electronic device 1 has a square outer shape (in the embodiment, rectangular shape, as an example) when viewed from the front side and the rear side, as an example. The housing 3 is configured to have a flattened rectangular parallelepiped shape that is thin in the front-rear direction (thickness direction of the housing 3, normal line direction of a display screen 4a). The housing 3 comprises a face 3a (front face, anterior face, surface, face portion), and a face 3b (rear face, posterior face, back face, face portion, see FIG. 4 and the like) at the side opposite the face 3a. The face 3a and the face 3b are provided so as to be oriented to the opposite sides (in the embodiment, so as to be in parallel with each other, as an example). The housing 3 comprises four ends 3c to 3f (sides, edges) and four corners 3g to 3j (sharp portions, bent portions, ends) when viewed from the front side. The ends 3c and 3e are examples of long sides. The ends 3d and 3f are examples of short sides. The housing 3 comprises four faces 3p (side faces, face portions) connecting the face 3a and the face 3b. The plurality of faces 3p are not necessarily distinguished from each other by sharpened corners or the like clearly and may be connected to each other through bent portions or the like smoothly.

The housing 3 comprises a wall 3k (portion, plate, frame, anterior wall, front wall, ceiling wall) located at the front side and a wall 3m (portion, plate, rear wall portion, back wall portion, bottom wall portion, see FIG. 4 and the like) located at the rear side. The walls 3k and 3m have square shapes (in the embodiment, rectangular shapes, as an example). The wall 3k is provided with a square-shaped opening 3r. The display screen 4a of a display device 4 is covered by a transparent portion of a touch panel 5 (touch sensor, input operation panel). The wall 3k surrounds a peripheral edge of the display device 4 (display screen 4a). The wall 3m is a square-shaped plate-like portion. The wall 3m covers the back face (not illustrated) of the display device 4 that is located opposite the display screen 4a. Furthermore, the housing 3 comprises four walls 3n (portions, plates, side walls, end walls, standing walls, connecting portions) connecting the wall 3k and the wall 3m. The walls 3n intersect with the walls 3k and 3m, and cover the side faces (not illustrated) of the display device 4 along the side faces. The walls 3k and 3m and the plurality of walls 3n are not necessarily distinguished from each other by sharpened corners or the like clearly, and may be connected to each other through bent portions or the like smoothly. The cross sections of the walls 3k and 3m and the wall 3n may be formed into continuous arc-like shapes. The walls 3k and 3m are substantially parallel with each other. The housing 3 can comprise a wall (portion, plate, frame, intermediate wall, inner wall, middle plate, middle frame, third wall, not illustrated) located between the wall 3k and the wall 3m.

In the embodiment, the housing 3 can be configured by combining a plurality of members (housing members, components, divided members), as an example. The members configuring the housing 3 can be made of synthetic resin materials (plastic, engineering plastic, and the like) and metal materials (aluminum alloy, magnesium alloy, stainless steel, and the like), for example.

In the embodiment, the housing 3 supports the display device 4, as an example. To be more specific, the housing 3 accommodates therein at least a portion of the display device 4 (display module, display, panel, display component). A user can check the display screen 4a visually through the opening 3r from the front side (anterior side). The display device 4 has an outer square shape (in the embodiment, rectangular shape, as an example) when viewed from the front side. Furthermore, the display device 4 is configured to have a flattened rectangular parallelepiped shape that is thin in the front-rear direction (thickness direction of the housing 3). For example, the display device 4 is a liquid crystal display (LCD) or an organic electroluminescent (EL) display (GELD). Note that the display device 4 can be a flexible display. The touch panel 5 can be configured as an in-cell touch panel incorporated in the display device 4.

Furthermore, in the embodiment, as illustrated in FIG. 2, the housing 3 accommodates therein circuit boards 11 (substrates, printed boards, control boards), wirings 13 (cables, harnesses, flexible cables, flexible print wiring boards, and the like), camera modules 14 (camera units, camera assemblies, cameras, image acquiring devices), a battery module 15 (battery, assembled battery, cell, module, battery pack, battery unit), speaker modules 16 (speaker units, speaker assemblies, speakers, audio output devices), an antenna module 17 (antenna unit, antenna assembly, antenna, first transmitting and receiving module), and the like as electric components 10 (components, first electric components) at the rear side (back side, rear side, wall 3m side, side opposite to the display screen 4a) of the display device 4, as an example. These electric components are electrically connected to other electric components through the wirings 13. Although not illustrated in FIG. 2, the housing 3 can accommodate therein a vibration generator (as an example, motor in which an eccentric weight is attached to a rotating shaft) and the like. In addition, the circuit boards 11 are provided (mounted) with various components 12 (electric components, elements, chips, packages, and the like) as the electric components 10.

In the embodiment, the battery module 15 can be configured as a lithium-ion secondary battery, as an example. In the embodiment, the battery module 15 can supply power supply power necessary for the electronic device 1 to perform operations of displaying video images, outputting audio, and so on to the display device 4 and the electric components mounted on the housing 3 through the wirings 13 and the like, as an example. Furthermore, the battery module 15 can also supply electric power to external devices and the like that are electrically connected to the circuit boards 11 and the like through the wirings 13, conductive portions (bus bars, not illustrated), connectors (not illustrated), or the like. In the embodiment, the battery module 15 has a square outer shape when viewed from the front side and the rear side and has a flattened shape that is thin in the thickness direction of the housing 3, as an example.

In the embodiment, for example, a plurality of components 12 such as a central processing unit (CPU), a graphic controller, a power supply circuit component, a platform controller hub (PCH), a memory slot connector, an LCD connector, an input/output (I/O) connecter, a power supply coil, an element, and a universal serial bus (USB) connector can be mounted on the circuit boards 11, as an example.

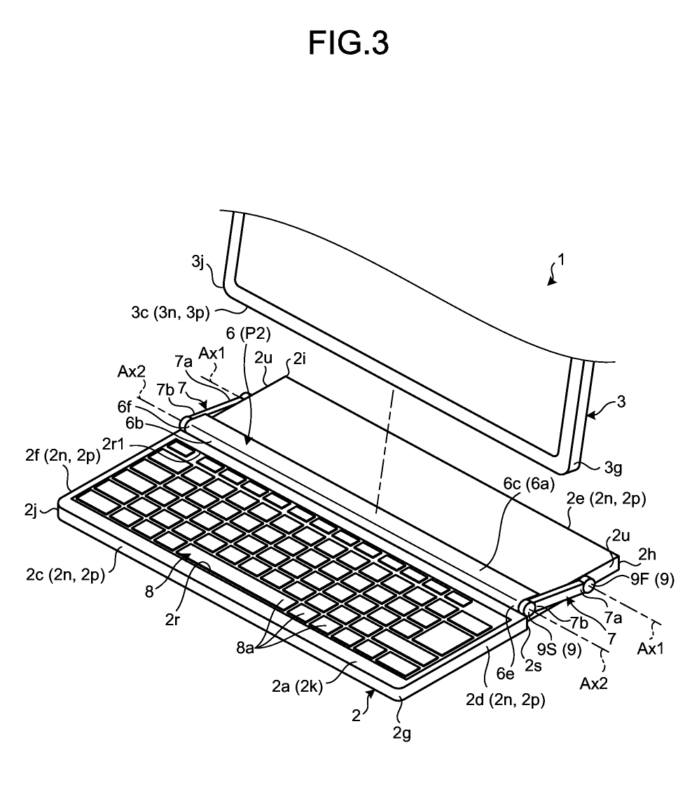

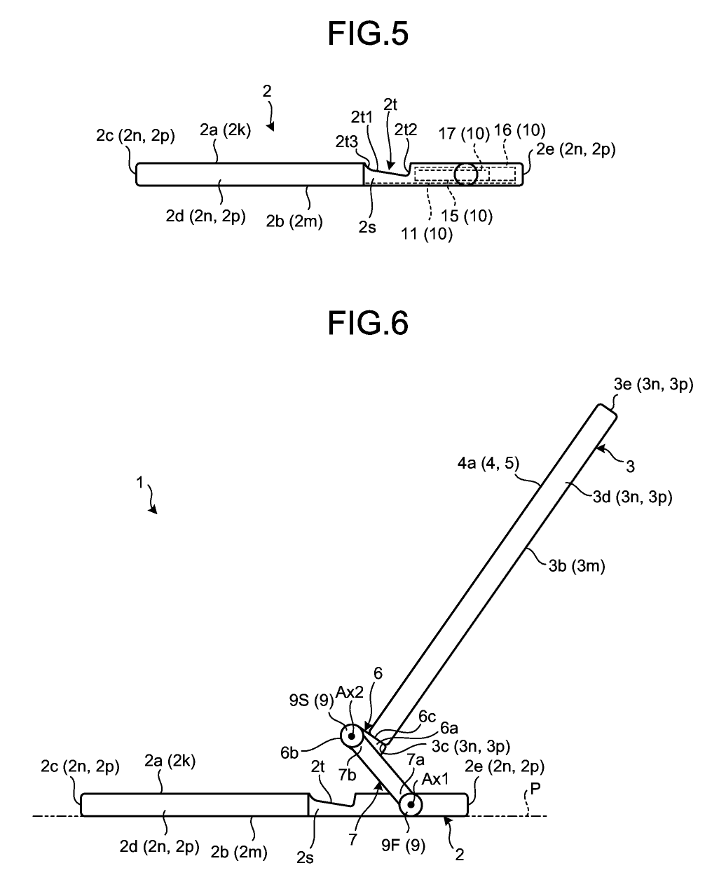

In the embodiment, as illustrated in FIGS. 1, 3, and the like, a housing 2 (second housing, stand, cradle, dock, docking station, support portion, holding portion) has a square outer shape (in the embodiment, rectangular shape, as an example) when viewed from the front side and the rear side, as an example. The housing 2 is configured to have a flattened rectangular parallelepiped shape that is thin in the up-down direction (thickness direction of the housing 2). The housing 2 comprises a face 2a (front, upper face, front face, face portion) and a face 2b (rear face, lower face, back face, face portion, see FIGS. 4, 5, and the like) at the side opposite the face 2a. The face 2a and the face 2b are provided so as to be oriented to the opposite sides (in the embodiment, so as to be in parallel with each other, as an example). The housing 2 comprises four ends 2c to 2f (sides, edges) and four corners 2g to 2j (sharp portions, bent portions, ends) when viewed from the front side. The ends 2c and 2e are examples of long sides. The ends 2d and 2f are examples of short sides. The housing 2 comprises four faces 2p (side faces, face portions) connecting the face 2a and the face 2b. The plurality of faces 2p are not necessarily distinguished from each other by sharpened corners or the like clearly, and may be connected to each other through bent portions or the like smoothly. In the embodiment, the end 2c is an example of a first end and the end 2e is an example of a second end, as an example.

Furthermore, in the embodiment, the housing 2 comprises a wall 2k (portion, plate, frame, upper wall, face wall, ceiling wall) located at the front side and a wall 2m (portion, plate, lower wall, back wall, bottom wall, see FIGS. 4, 5, and the like) located at the rear side, as an example. The electronic device 1 can be placed on a placement surface P (see, FIG. 4) in a posture in which the face 2b (wall 2m) of the housing 2 is along the placement surface P, as an example. The walls 2k and 2m have square shapes (in the embodiment, rectangular shapes, as an example). Furthermore, the housing 2 comprises four walls 2n (portions, plates, side walls, end walls, standing walls, connecting portions) connecting between the wall 2k and the wall 2m. The walls 2n intersect with the walls 2k and 2m. The wall portions 2k and 2m and the walls 2n are not necessarily separated from each other clearly, and may be connected to each other through bent portions or the like smoothly. The cross sections of the walls 2k and 2m and the wall 2n may be formed into continuous arc-like shapes. The housing 2 can comprise a wall (portion, plate, frame, intermediate wall, inner wall, middle plate, middle frame, third wall, not illustrated) located between the wall 2k and the wall 2m.

In the embodiment, the housing 2 can be configured by combining a plurality of members (housing members, components, divided members), as an example. The members configuring the housing 2 can be made of synthetic resin materials (plastic, engineering plastic, and the like) and metal materials (aluminum alloy, magnesium alloy, stainless steel, and the like), for example.

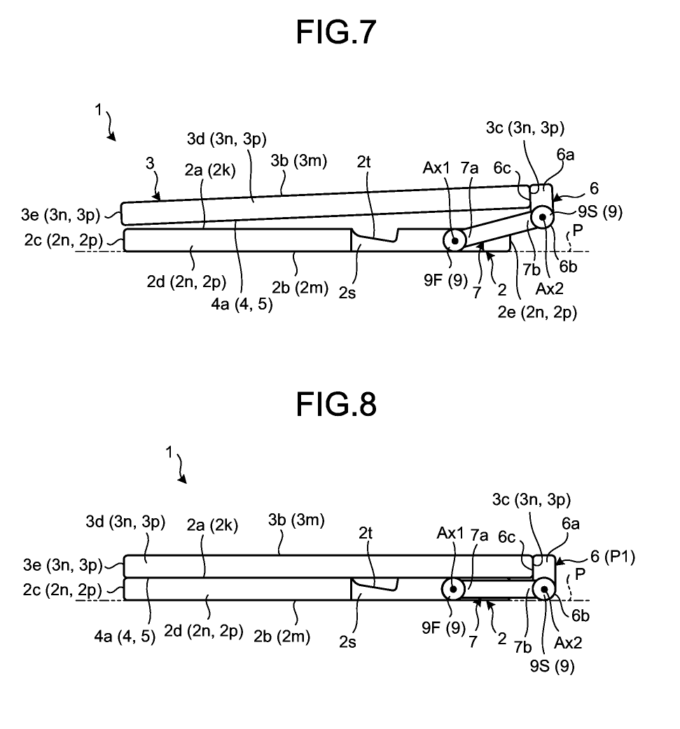

In the embodiment, as illustrated in FIGS. 4 to 9 and the like, a groove-like recess 2t (recessed groove, accommodating portion) is provided to the wall 2k at an intermediate portion 2s between the end 2c and the end 2e, as an example. The recess 2t extends in substantially parallel with the ends 2c and 2e. As is obvious from FIGS. 3 to 6, a connection portion 6 (movable portion) is inserted into the recess 2t.

Furthermore, in the embodiment, the wall 2k is provided with an opening 2r having a square shape, as an example. That is to say, the wall 2k is formed into a square-shaped frame form. A keyboard module 8 (keyboard, input operation module, input receiver) comprising a plurality of keys 8a is exposed from the opening 2r. The keyboard module 8 is an example of the electric component 10. The opening 2r (keyboard module 8) is located between the end 2c and the intermediate portion 2s (recess 2t). The opening 2r is provided across a region between the end 2c and the intermediate portion 2s. The opening 2r is provided in the housing 2 at the end 2c side relative to the intermediate portion 2s. The opening 2r extends to the vicinity of the intermediate portion 2s from the vicinity of the end 2c. The opening 2r (keyboard module 8) occupies a relatively large region of a rectangular region of the wall 2k at the end 2c side relative to the intermediate portion 2s. That is to say, an end 2r1 of the opening 2r at the side opposite to the end 2c is located on the intermediate portion 2s (in the vicinity of the recess 2t).

Furthermore, in the embodiment, as illustrated in FIG. 5, the housing 2 accommodates therein the circuit board 11 (substrates, printed boards, control boards), the battery module 15 (battery, assembled battery, cell, module, battery pack, battery unit), the speaker module 16 (speaker unit, speaker assembly, speaker, audio output device), the antenna module 17 (antenna unit, antenna assembly, antenna, second transmitting and receiving module), and the like as the electric components 10 (components, second electric components) at the end 2e side (rear side, side opposite to the end 2c, side opposite the keyboard module 8) relative to the intermediate portion 2s, as an example. In the embodiment, the keyboard module 8 and the electric components 10 other than the keyboard module 8 are arranged at the opposite sides with the intermediate portion 2s disposed therebetween, as an example. With this arrangement, according to the embodiment, the housing 2 is easy to be made thin in comparison with the case where the keyboard module 8 and the electric components 10 other than the keyboard module 8 are accommodated so as to be superimposed in the thickness direction of the housing 2, as an example.

In the embodiment, the antenna module 17 of the housing 2 wirelessly communicates with the antenna module 17 (see, FIG. 2) of the housing 3 so as to transmit and receive data to and from it, as an example. The data that is transmitted to the antenna module 17 of the housing 3 from the antenna module 17 of the housing 2 is data in accordance with (indicating) an input operation on the keyboard module 8, for example. The data that is transmitted to the antenna module 17 of the housing 2 from the antenna module 17 of the housing 3 is data for outputting audio through the speaker module 16 of the housing 2, for example. Based on this, in the embodiment, the electric components 10 of the housing 2 can function as an input module or an output module of the housing 3 (that corresponds to a controller (not illustrated)), as an example. That is to say, the housing 2 is an example of a function expansion device of the housing 3.

Furthermore, in the embodiment, the connection portion 6 is configured into a columnar form (or cylindrical form, bar form) that is elongated in parallel with the direction (lengthwise direction of the housing 2) in which the ends 2c and 2e extend, as an example. The connection portion 6 comprises a rectangular columnar part 6a and a semicircular columnar part 6b. The recess 2t is configured by planar portions 2t1 and 2t2 corresponding to the rectangular columnar part 6a (along (that makes contact with) the rectangular columnar part 6a) and a curved face 2t3 corresponding to the semicircular columnar part 6b (along (that makes contact with) the semicircular columnar part 6b) in accordance with the shape of the connection portion 6. The planar portions 2t1 and 2t2 intersect with (are perpendicular to) each other. The curved face 2t3 is continuous to the planar portion 2t1 so as to form the front face (side face) of the recess 2t. The planar portion 2t1 forms the lower face (bottom face) of the recess 2t, and the planar portion 2t2 forms the rear face (side face) of the recess 2t. The connection portion 6 is accommodated (inserted) in (into) the recess 2t in a state of making contact with at least two of the planar portions 2t1 and 2t2 and the curved face 2t3 of the recess 2t at least partially. That is to say, the planar portions 2t1 and 2t2 and the curved face 2t3 are examples of a support supporting the connection portion 6.

Furthermore, in the embodiment, as illustrated in FIGS. 1 and 3, the end 3c of the housing 3 is detachably connected to a face 6c of the connection portion 6, as an example. In a state in which the housing 3 and the connection portion 6 are connected (the housing 3 is supported (held) on the connection portion 6), the housing 2 and the housing 3 can be used in an opened state in a clamshell mode in which the housing 2 and the housing 3 are connected in a rotationally movable manner through hinges 9. The housing 3 can be also used in a tablet mode in which the housing 3 is separated from the connection portion 6 (not connected to the connection portion 6). The face 6c of the connection portion 6 is configured in a planar form and is exposed to the outer side of the housing 2 relative to the face 2a in a state in which the connection portion 6 is accommodated in the recess 2t. Furthermore, in the embodiment, a permanent magnet is provided on the connection portion 6 so as to attract a magnetic member provided on the housing 3 magnetically, as an example. For example, the magnetic member can be the wall 3n that is made of a metal material, a metal material that is insert-molded in the wall 3n made of a synthetic resin, a permanent magnet of the wall 3n that is provided in the housing 3 and is different from the wall 3n. It is to be noted that the permanent magnet may be provided on the housing 3 and the magnet member attracted by the permanent magnet may be provided on the connection portion 6. Furthermore, a mechanism (structure, engagement mechanism, hooking mechanism, or the like, not illustrated) for connecting the housing 3 and the connection portion 6 mechanically in a detachable manner can be provided on at least one of the housing 3 and the connection portion 6. Moreover, a mechanism (structure, recess-protrusion shape, recess, protrusion, not illustrated) for positioning the housing 3 and the connection portion 6, a mechanism (structure, recess-protrusion shape, recess, protrusion, not illustrated) for guiding attachment and detachment between the housing 3 and the connection portion 6, and the like can be provided on at least one of the housing 3 and the connection portion 6.

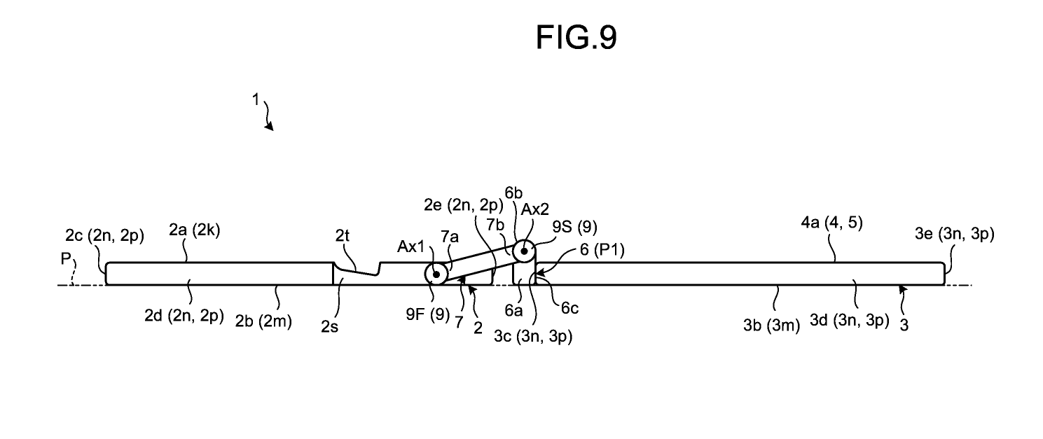

In the embodiment, the connection portion 6 is rotatably connected to (supported on) the housing 2 through a plurality of (in the embodiment, two as an example) movable portions 7 (arm portions, arms, rotational moving portions), as an example. One movable portion 7 (movable portion 7 at the right side in FIG. 3) connects the end 2d of the housing 2 and the end 6e of the connection portion 6 at one side. The other movable portion 7 (movable portion 7 at the left side in FIG. 3) connects the end 2f of the housing 2 and the end 6f of the connection portion 6 at the other hand. One end 7a of each movable portion 7 is rotatably connected to (the end 2d or the end 2f of) the housing 2 through a first hinge 9F (hinge 9). Furthermore, the other end 7b of each movable portion 7 is rotatably connected to (the end 6e or the end 6f of) the connection portion 6 through a second hinge 9S (hinge 9). With this configuration, the connection portion 6 can be moved between a first position P1 (see FIG. 8) and a second position P2 (see FIGS. 1, 3, and 4). The connection portion 6 is close to (near, adjacent to, comes closer to) the end 2e (first end) at the first position P1. The connection portion 6 is supported on (close to, near, adjacent to, comes closer to) the intermediate portion 2s at the second position P2. That is to say, in the embodiment, the movable portions 7 move the connection portion 6 between the first position P1 and the second position P2), as an example. The connection portion 6, the movable portions 7, and the housing 3 can be moved between the first position P1 (see FIG. 8) and the second position P2 (see FIG. 4) while being changed to postures (shapes) as illustrated in FIGS. 4, 6 to 8. As illustrated in FIG. 4, in the state in which the connection portion 6 is located at the second position P2, the housing 2 and the housing 3 can be opened with respect to each other (opened state). As illustrated in FIG. 8, in the state in which the connection portion 6 is located at the first position P1, the housing 2 and the housing 3 can be folded (folded state). As illustrated in FIG. 9, in the state in which the connection portion 6 is located at the first position P1, the housing 2 and the housing 3 can be also developed (flat state). The movable portions 7 are located at the outer sides of the ends 2d and 2f along the end 2d and the end 2f of the housing 2. Recesses 2u accommodating therein the movable portions 7 are provided to parts of the ends 2d and 2f of the housing 2 that connect the end 2e and the intermediate portion 2s. The first position P1 is an example of a position at which the end 3c (first end) of the housing 3 is near (closer to, adjacent to) the end 2e (second end) of the housing 2. The second position P2 is an example of a position at which the end 3c (first end) of the housing is near (closer to, adjacent to) the intermediate portion 2s between the end 2e (second end) and the end 2c (third end) of the housing 2.

In the embodiment, as illustrated in FIG. 1, in the state in which the connection portion 6 is located at the second position P2, the (housing 3 supporting) display device 4 with the touch panel 5 projects from the intermediate portion 2s, as an example. The keyboard module 8 is provided across the region between the intermediate portion 2s and the end 2c. According to the embodiment, the display device 4 with the touch panel 5 as the input operation module and the keyboard module 8 as another input operation module can be arranged so as to be closer to each other in a state (posture) in which the housing 3 comprising the display device 4 stands. This enables an operator (user) to switch a state of operating the keyboard module 8 with his or her hands and fingers and a state of operating the touch panel 5 with his or her hands and fingers relatively easily or relatively quickly, as an example.

Furthermore, in the configuration in which the housing 3 is made to stand from the end 2e of the housing 2 as in a conventional general cram-shell personal computer, when an external force to the rear side (back side, side opposite the display screen 4a) is applied to the housing 3 when the operator (user) pushes the display screen 4a and so on, the electronic device 1 is fell backward (tipped over) in some cases. When the weight of the housing 3 is relatively large because the housing 3 comprises the battery module 15 and so on, such case is easily generated. For coping with this point, in the embodiment, as illustrated in FIGS. 1, 4, and the like, when the housing 3 is in the posture of standing from the housing 2, the housing 3 projects from the intermediate portion 2s of the housing 2. That is to say, in this state, the portion of the housing 2 between the intermediate portion 2s and the end 2e is located at the rear side relative to the end 3c of the housing 3 at the lower side (placement surface P side). With this configuration, according to the embodiment, even when the external force to the rear side is applied to the housing 3, the electronic device 1 is difficult to be fell backward (tipped over), as an example.

In the embodiment, as described above, the connection portion 6 is accommodated in the recess 2t in the state of being located at the second position P2, so that the connection portion 6, eventually, the housing 3 are easy to be supported on the housing 2 more stably, as an example.

Furthermore, in the embodiment, as illustrated in FIG. 4, in the state in which the connection portion 6 is located at the second position P2, the connection portion 6 is accommodated in the recess 2t in the posture (inclined posture) where the face 6c is close to the placement surface P toward the rear side (opposite the display screen 4a, the right side in FIG. 4), as an example. That is, in the embodiment, in the state in which the connection portion 6 is located at the second position P2, the housing 3, eventually, the display device 4 (display screen 4a) are supported by the housing 2 in the postures inclined to the rear side (posture where the housing 3 and the display device 4 are close to the rear side as they are farther from the placement surface P), as an example. With this configuration, the display screen 4a is easy to be viewed in comparison with the case in which the housing 3, eventually, the display device 4 are supported on the housing 2 in the postures of being perpendicular to the placement surface P, as an example.

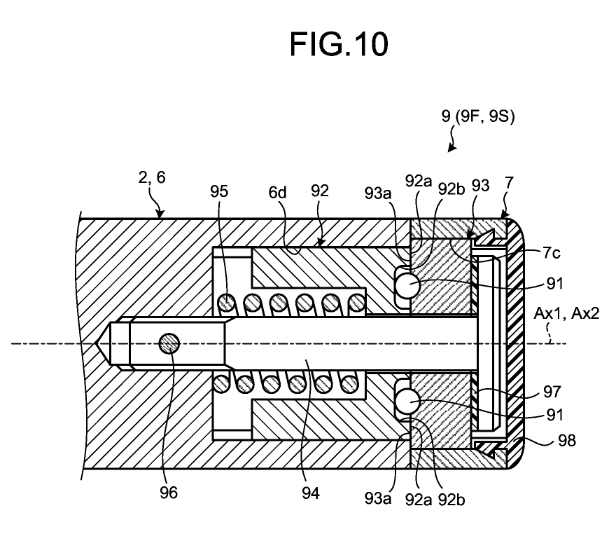

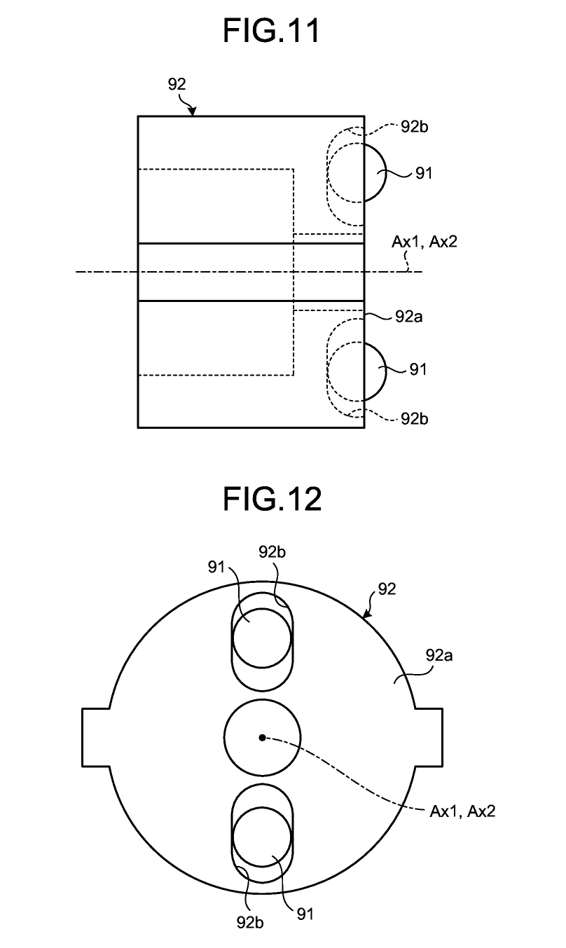

In the embodiment, each hinge 9 (first hinge 9F and second hinge 9S) can have a configuration as illustrated in FIGS. 10 to 12, as an example. To be more specific, the hinge 9 comprises balls 91, ball holders 92, ball guides 93, a coupling tool 94, elastic members 95, a rotation locking portion 96, sliding portions 97, a cover portion 98, and the like. These components are accommodated in any of an opening 6d provided on the housing 2 or the connection portion 6 and an opening 7c provided on the movable portion 7. The opening 6d and the opening 7c are continuous to each other. For example, the balls 91 are steel spheres. The ball holders 92 are accommodated in the opening 6d. The ball holders 92 are supported on the housing 2 or the connection portion 6 in a reciprocatable manner in the shaft direction of the rotating shafts Ax1 and Ax2 while being unmovable in the circumferential directions and the radial directions of the rotating shafts Ax1 and Ax2. The ball holders 92 can be moved rotationally about the rotating shafts Ax1 and Ax2 together with the housing 2 or the connection portion 6. The ball guides 93 are accommodated in the opening 7c. The ball guides 93 can be moved rotationally about the rotating shafts Ax1 and Ax2 together with the movable portion 7 integrally. The coupling tool 94 (in the embodiment, screw as an example) penetrates through the ball holders 92 and the ball guides 93 so as to be coupled to the housing 2 or the connection portion 6. The coupling tool 94 suppresses separation of the respective components, the housing 2 or the connection portion 6, the movable portion 7, and the like in the direction along the rotating shafts Ax1 and Ax2. The rotation locking portion 96 penetrates through the coupling tool 94 so as to be fixed to the housing 2 or the connection portion 6. That is to say, the coupling tool 94 is moved rotationally about the rotating shafts Ax1 and Ax2 integrally with the housing 2 or the connection portion 6. The elastic members 95 (for example, coil springs) generate forces of pressing the ball holders 92 and the ball guides 93 through the balls 91. The balls 91 are made into states of being sandwiched between the ball holders 92 and the ball guides 93 depending on the rotational movement positions. The sliding portions 97 enhance sliding property between the coupling tool 94 and the ball guides 93. As illustrated in FIGS. 11 and 12, recesses 92b accommodating therein the balls 91 are provided on faces 92a of the ball holders 92 that are opposed to the ball guides 93. The recesses 92b extend along the radial directions of the rotating shafts Ax1 and Ax2. That is to say, the ball holders 92 hold the balls 91 so as to be movable in the radial directions.

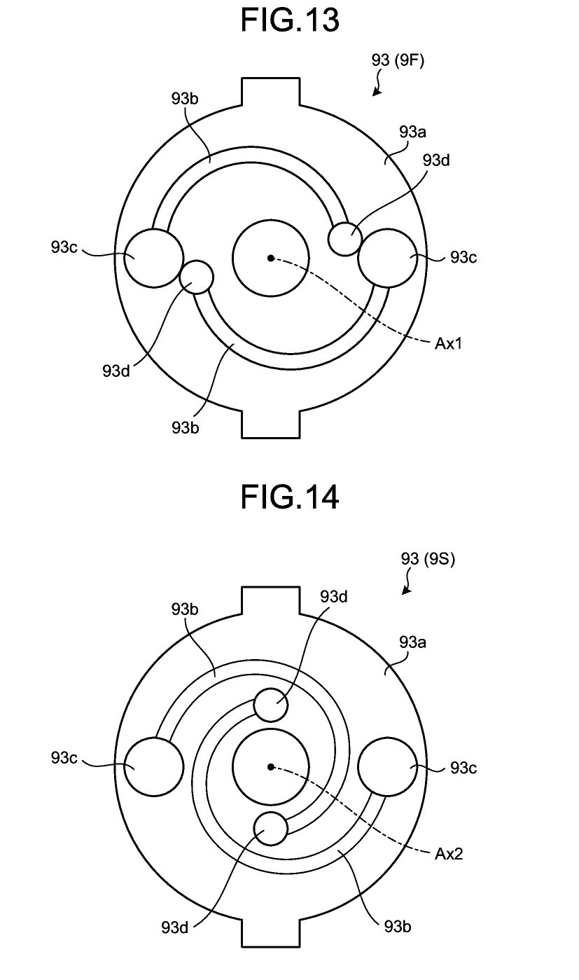

The first hinge 9F comprises the ball guide 93 as illustrated in FIG. 13. Recesses 93b (recessed grooves, guide portions, rails) guiding the ball 91 are provided on a face 93a of the ball guide 93 that is opposed to the ball holder 92. The recesses 93b are formed in circular-arc shapes around the rotating shaft Ax1. Recesses 93c and 93d that are deeper than the recesses 93b are provided at both ends of the recesses 93b. The ball 91 can reciprocate between the recesses 93c and the recesses 93d in a rolling manner along the recesses 93b. The recesses 93b are close to one side in the radial direction (for example, inner side in the radial direction) toward one side (for example, clockwise direction) in the circumferential direction such that a plurality of combinations of the recesses 93b, 93c, and 93d can be arranged. The recess 92b of the ball holder 92 extends in the radial direction so as to follow (correspond to) the change in the position of the ball 91 in the radial direction with the change in the positions of the recesses 93b in the radial direction. With this configuration, when the ball 91 is moved to the recesses 93b from the recesses 93c and 93d, the ball 91 climbs over steps between the recesses 93c and 93d and the recesses 93b. A resistance force acting on the ball 91 by a pressing force (biasing force, set load, initial load) of the elastic member 95 when the ball 91 climbs over the steps causes the operator to feel a click sense when moving the housing 2 and the movable portion 7 rotationally relatively and generates a holding torque (resistance torque) with which the connection portion 6 is held at each of the first position P1 and the second position P2.

The second hinge 9S comprises the ball guide 93 as illustrated in FIG. 14. The ball guide 93 as illustrated in FIG. 14 has the configuration same as the ball guide 93 of the first hinge 9F as illustrated in FIG. 13 other than a point in specs (shapes) of the recesses 93b. Also with this configuration, when the ball 91 is moved to the recesses 93b from the recesses 93c and 93d, the ball 91 climbs over steps between the recesses 93c and 93d and the recesses 93b. A resistance force acting on the ball 91 by a pressing force of the elastic member 95 when the ball 91 climbs over the steps causes the operator to feel a click sense when moving the connection portion 6 and the movable portion 7 rotationally relatively and generates a holding torque (resistance torque) with which the connection portion 6 is held at each of the first position P1 and the second position P2. Furthermore, the housing 2, the movable portion 7, and the connection portion 6 (eventually housing 3) can be held (maintained) at arbitrary angles (in an arbitrary postures, states) by setting a pressing force of the elastic member 95 of at least one of the first hinge 9F and the second hinge 9S appropriately.

As described above, in the embodiment, the electronic device 1 comprises the connection portion 6 and the movable portions 7, as an example. The connection portion 6 is detachably connected to the housing 3 (first housing). The movable portions 7 are rotatably supported on the housing 2 (second housing) and move the connection portion 6 between the first position P1 at which it is close to the end 2e (first end) and the second position P2 at which it is supported by the intermediate portion 2s. In the state in which the connection portion 6 is located at the first position P1, the housing 2 and the housing 3 can be folded. In the state in which the connection portion 6 is located at the second position P2, the housing 2 and the housing 3 can be opened. According to the embodiment, the state in which the end 3c of the housing 3 makes close to (adjacent to) the intermediate portion 2s of the housing 2 can be made in the opened state, as an example. In the opened state as illustrated in FIGS. 1 and 4, the electronic device 1 is difficult to be fell down (tipped over). Furthermore, as illustrated in FIG. 8, in the state in which the connection portion 6 is located at the first position P1, the housing 2 can cover the display screen 4a of the housing 3 by folding the housing 2 and the housing 3, as an example.

In the embodiment, the electronic device 1 comprises the touch panel 5 (input operation module) that detects an input operation on the display screen 4a, as an example. With this, even when the external force is applied to the housing 3 by the input operation onto the touch panel 5 in the opened state as illustrated in FIGS. 1 and 4, the electronic device 1 is more difficult to be fell down (tipped over), as an example.

Furthermore, in the embodiment, the electronic device 1 comprises the keyboard module 8 (input operation module) between the end 2c (second end) and the intermediate portion 2s of the housing 2 (second housing), as an example. According to the embodiment, the keyboard module 8 and the touch panel 5 are arranged to be close to each other easily, as an example. This enables the operator (user) to switch the state of operating the keyboard module 8 with his or her hands and fingers and the state of operating the touch panel 5 relatively easily or relatively quickly in the developed state as illustrated in FIGS. 1 and 4, as an example.

In the embodiment, the electronic device 1 comprises the recess 2t (accommodating portion) that is located on the intermediate portion 2s and accommodates therein the connection portion 6, as an example. According to the embodiment, the connection portion 6 is easy to be supported more stably in the opened state as illustrated in FIGS. 1 and 4, as an example. With this, the housing 3 is more difficult to be felled down (inclined), as an example.

Furthermore, in the embodiment, the electronic device 1 comprises the electric components 10 that are provided between the end 2e (first end) and the intermediate portion 2s of the housing 2 (second housing) and are electrically connected to the keyboard module 8 (input operation module), as an example. With this, the housing 2 is made thinner easily, as an example.

Furthermore, in the embodiment, the electronic device 1 comprises the first hinges 9F and the second hinges 9S, as an example. The first hinges 9F rotatably connect the housing 2 (second housing) and the movable portions 7 with respect to each other. The second hinges 9S rotatably connect the connection portion 6 and the movable portions 7 with respect to each other. With this, according to the embodiment, the configuration in which the connection portion 6 is moved between the first position P1 and the second position P2 is easy to be obtained as a relatively simple configuration, as an example.

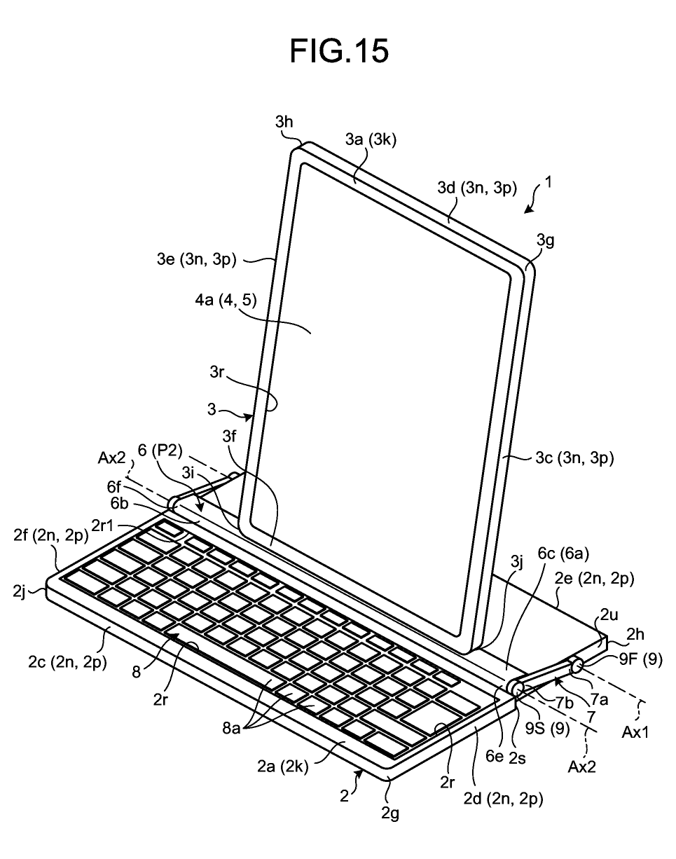

In the embodiment, as illustrated in FIG. 15, the connection portion 6 can support the housing 3 (can be connected to the housing 3) in a posture (state) different from that in FIG. 1. In the posture (state) as illustrated in FIG. 15, the housing 3 comprising the display device 4 is a what-is-so-called vertically set so as to be elongated in the up-down direction. Although not illustrated in FIG. 15, the connection portion 6 can support the housing 3 (be connected to the housing 3) in the posture of which front and rear sides are reversed from the posture as illustrated in FIGS. 1 and 15 (state, that is, posture in which the display screen 4a faces the rear side opposite to that in FIGS. 1 and 15). In the configuration in which the connection portion 6 and the housing 3 are connected by attraction of the permanent magnet and the magnetic member, the posture of the housing 3 can be changed in various manners relatively easily.

### SECOND EMBODIMENT

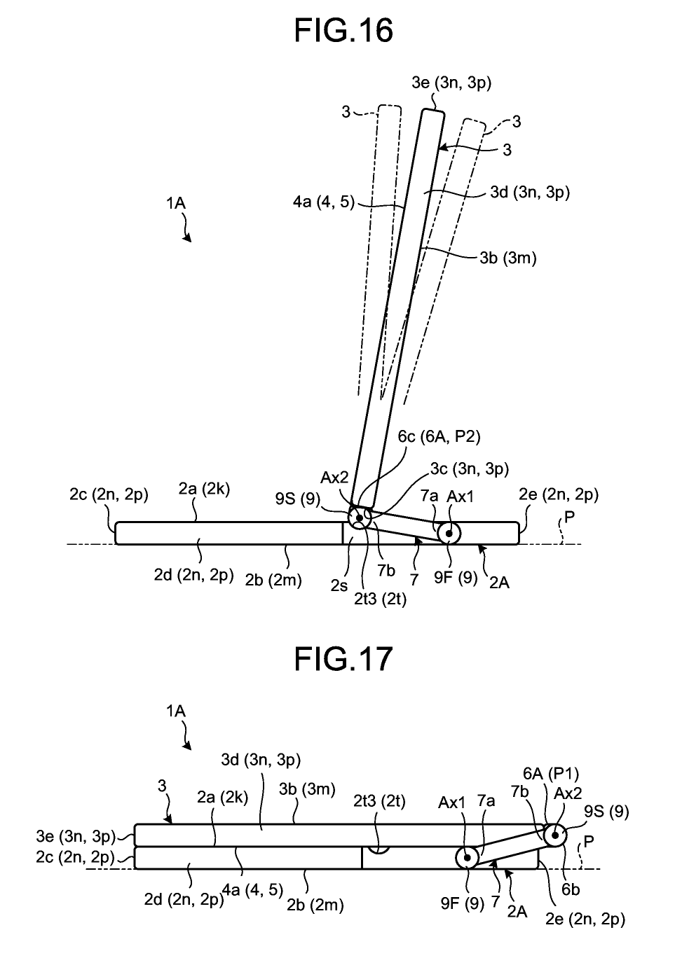

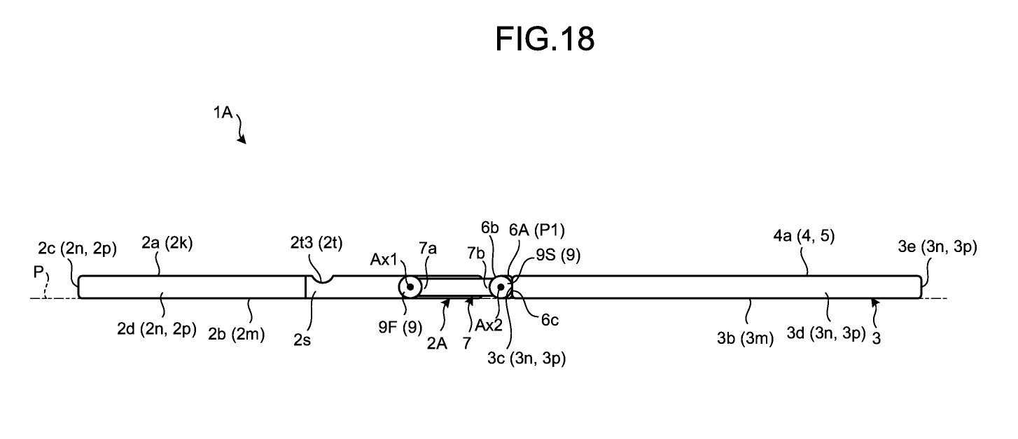

A housing 2A of an electronic device 1A according to a second embodiment as illustrated in FIGS. 16 to 18 has the same configuration as the housing 2 of the electronic device 1 according to the above-mentioned first embodiment. With this, the same results (advantageous effects) based on the same configuration as that in the above-mentioned first embodiment can be also obtained in the embodiment. Note that in the embodiment, the shapes of a connection portion 6A and the recess 2t are different from those of the connection portion 6 in the above-mentioned first embodiment. That is to say, in the embodiment, the width of the connection portion 6A is smaller than the width of the connection portion 6, as an example. According to the embodiment, as illustrated in FIG. 17, the connection portion 6A is located at the upper side relative to that in the above-mentioned first embodiment at the first position P1, as an example. According to the embodiment, as illustrated in FIG. 18, the electronic device 1A comprising the connection portion 6A and the movable portions 7 can be deformed into a more flat state (posture) overall, as an example. In the embodiment, a recess-protrusion configuration (for example, projections (protrusion) or openings (recesses) provided at an interval, a spline, a gear, and the like, not illustrated), a friction element (resistance element, for example, elastomer), and the like are provided on at least one of the connection portion 6A and the circular columnar surface-like curved face 2t3 of the recess 2t, as an example. According to the embodiment, as illustrated in FIG. 16, the housing 2A can support (hold) the connection portion 6A accommodated in the recess 2t at a plurality of (various) angles obtained by moving the connection portion 6A rotationally along the circular columnar surface-like curved face 2t3 of the recess 2t, as an example. An angle formed by the movable portions 7 and the connection portion 6A can be set arbitrarily by setting pressing forces of the elastic members 95 of the second hinges 9S appropriately. Also in this case, the angle formed by the housing 2A and the housing 3 can be set variably.

The respective constituent components can be made to function while changing the specs (configurations, types, directions, shapes, sizes, lengths, widths, thicknesses, heights, numbers, arrangement, positions, materials) thereof appropriately. For example, an accommodating portion accommodating therein apart of the first housing may be provided on the electronic device (stand) instead of the connection portion. Furthermore, a configuration in which the first housing and the connection portion are integrated and the movable portions are connected to the ends of the first housing in a rotationally movable manner can be employed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display device comprising a display screen;
a touch panel configured to detect an input operation on the display screen;
a first housing configured to support the display device;
a second housing comprising a first end, a second end opposite the first end, and an intermediate portion between the first end and the second end;
a connection portion detachably connected to the first housing; and
a movable portion configured to be rotatably supported by the second housing and to move the connection portion between a first position at which the connection portion is close to the first end and a second position at which the connection portion is supported by the intermediate portion, wherein,
in a state in which the connection portion is located at the first position, the first housing and the second housing are foldable, and,
in a state in which the connection portion is located at the second position, the first housing and the second housing are openable.

2. The electronic device of claim 1, further comprising an input operation module located between the second end and the intermediate portion of the second housing.

3. The electronic device of claim 1, further comprising an accommodating portion located on the intermediate portion and configured to accommodate therein the connection portion.

4. The electronic device of claim 3, wherein the connection portion is accommodated in the accommodating portion so that an angle formed by the display screen and the second housing is variable.

5. The electronic device of claim 1, further comprising:
a first electric component provided to the first housing;
a second electric component provided to the second housing;
a first transmitting and receiving module provided to the first housing, electrically connected to the first electric component, and configured to wirelessly transmit and receive data; and
a second transmitting and receiving module provided to the second housing, electrically connected to the second electric component, and configured to wirelessly transmit and receive data to and from the first transmitting and receiving module.

6. The electronic device of claim 1, wherein the connection portion is configured to be capable of supporting the first housing in a plurality of different postures.

7. The electronic device of claim 2, further comprising an electric component provided between the first end and the intermediate portion of the second housing and electrically connected to the input operation module.

8. The electronic device of claim 1, further comprising:
a first hinge configured to rotatably connect the second housing and the movable portion with respect to each other; and
a second hinge configured to rotatably connect the movable portion and the connection portion with respect to each other.

9. A stand for an electronic device, the electronic device comprising a display device and a housing, the display device comprising a display screen, the housing being configured to detachably support the electronic device, the stand being configured to detachably support the electronic device, the stand comprising:
a support comprising a first end, a second end opposite the first end, and an intermediate portion between the first end and the second end;
a connection portion detachably connected to the housing; and
a movable portion configured to move the connection portion between a first position at which the connection portion is close to the first end and a second position at which the connection portion is supported by the intermediate portion, wherein, in a state in which the connection portion is located at the first position, the housing and the support portion are foldable, and,
in a state in which the connection portion is located at the second position, the housing and the support portion are openable.

10. An electronic device comprising:
a first housing comprising a first end;
a second housing comprising a second end, a third end opposite the second end, and an intermediate portion between the second end and the third end, and
a movable portion configured to move the first end between a first position at which the first end is close to the second end and a second position at which the first end is close to the intermediate portion, wherein,
in a state in which the first end is located at the first position, the first housing and the second housing are foldable, and,
in a state in which the first end is located at the second position, the first housing and the second housing are openable.
